(19) United States
(12) Patent Application Publication
(10) Pub. No.: US 2008/0027771 A1
(43) Pub. Date: Jan. 31, 2008

(54) SELECTION PROCESS

(75) Inventor: Piers D.G. Steel, Calgary (CA)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: UTI LIMITED PARTNERSHIP, Calgary (CA)

(21) Appl. No.: 11/682,267

(22) Filed: Mar. 5, 2007

Related U.S. Application Data
(60) Provisional application No. 60/820,515, filed on Jul. 27, 2006.

(51) Int. Cl. G06F 17/00

(52) U.S. Cl. 705/7

(57) ABSTRACT

A method of selecting an applicant for a function, such as a job. Coefficients are established between performance characteristics of a large number of jobs and performance predictors relating to persons who perform the jobs. A prediction equation is obtained for a specific job using the coefficients, and then an applicant is assessed in relation to that prediction equation.

### CROSS-REFERENCE TO RELATED APPLICATIONS

This application claims the benefit under 35 USC 119 of provisional application No. 60/820,515 filed Jul. 27, 2006.

### BACKGROUND

The ability to select the right person for the right job is critical for a company's competitive success. At a national level, widespread good selection practices can literally add tens to hundreds of billions of dollars to a country's coffers. Good hires can easily be worth three or four times their salary. Bad hires can cost money, where it actually would be better if the person was paid to stay at home. Unfortunately, creating a good selection system, with its appropriate test and interview questions, often requires input from expensive personnel experts and weeks of time to develop appropriate algorithms for employee selection. Making sure it stands up to legal requirements can extend that preparation into months, require over a 100 employees, and cost many tens of thousands of dollars. Because of this difficulty, only a minority of large companies have adequate selection system and even fewer smaller companies. Hence, it would be useful to develop a selection system for a new job based on information obtained previously about other jobs.

### SUMMARY

There is provided a method of making an objective selection of an applicant for a specific function using a computer managed selection system, the specific function being one of a set of functions having at least some performance characteristics in common. The steps included establishing a set of coefficients relating performance characteristics of the set of functions to performance predictors, each of the performance predictors being predictive of the ability of a potential applicant for at least one function of the set of functions to perform the at least one function. A set of performance characteristics selected from the performance characteristics and that relate to the specific function is then generated. An applicant is then subject to a test to find performance predictors relating to that applicant for the specific function. From the coefficients relating the performance characteristics to the performance predictors, a prediction equation is found from which it is determined whether the performance predictors predict that the applicant should be selected for the specific function based on the predicted overall performance of the applicant for the specific function.

### BRIEF DESCRIPTION OF THE FIGURES

Embodiments will now be described with reference to the figures, in which like reference characters denote like elements, by way of example, and in which:

FIG. 1 is a flow diagram of the basic steps used in a selection process;

FIG. 2 shows an example of a matrix of covariances; and

FIG. 3 shows percentage of employees performing general work behaviors (GWBs) to an acceptable level as a function of general mental ability.

### DETAILED DESCRIPTION

A method is described of making an objective selection of an applicant for a specific function using a computer managed selection system based on predicted overall performance of the applicant for the specific function. The method is a type of process known as synthetic validity. A specific function in one embodiment is a job. This particular embodiment will be described in some detail, providing exemplary steps in the method. The computer managed selection system may be internet based. Prior to carrying out the selection of an applicant for a specific job, a computer (of any suitable kind) must be programmed according to the method steps provided here and include a database of information concerning a variety of jobs (a set of functions) that have at least some performance characteristics in common.

Before setting up the computer managed selection system, the performance characteristics used to define the functions must be established. Work behaviors, which are themselves known in the art, eliminate the inference between job elements and overall performance. That is, overall performance can be defined as the weighted sum of relevant work behaviors, as determined by a job analysis. General work behaviors (GWBs), also known as generalized work activities (GWAs), are behavioral descriptors that are applicable across a wide range of occupations. GWBs are potentially applicable for virtually all jobs.

GWBs must be defined to avoid deficiency. Deficiency is the exclusion of an important job element, with consequent failure to identify fully overall performance. If this happens, the synthetic validity system may select employees who perform well in some but not all areas. Of known GWBs, exemplary categories of GWBs that may be used include non-job-specific task proficiency, written and oral communication proficiency, demonstration of effort, maintenance of personal discipline, facilitation of peer and team performance, supervision/leadership, and management/administration.

There can be a large number of GWBs. For some embodiments, to reduce complexity, the range of jobs (set of functions) for which a selection procedure is established may have to be limited to a single job family, such as sales. Within a single job family, relatively few job-specific behaviors are likely to be needed to fully describe all jobs. When that is completed, we continue the process, expanding to other job families with their own collection of job-specific tasks.

GWBs must be assessed at the appropriate level of precision, and constructed and administered to maximize reliability and validity. There is a trade-off between having too many GWBs, which may not be transportable, and having too few, which may be inadequate to create a generalized relationship with a specific performance predictor. Leaving aside job complexity, an approximate number of GWBs ranges from 42 to 78, as per known job analysis questionnaires. However, this does not take into account job complexity. As a job analysis tool, level of complexity is inherent in each factor. However, when used as a performance dimension for synthetic validity, complexity needs to be broken out. Level of task complexity, aside from being required for legal reasons (Uniform Guidelines on Employee Selection Procedures, 1978), will moderate a GWB's relationship with at least some predictors. The more complicated the job, the greater the demands it makes on an individual's attributes. Previous work has suggested breaking down complexity into three levels. Thus, the number of general work behaviors we may need to assess all jobs is between 42 and 78 (i.e., the dimensions of the job analysis questionnaires) multiplied by the three levels of complexity. Thus in some embodiments, there could be as few as 126 or as many as 234 GWBs. In one embodiment, the 42 GWBs of the well known O*NET system may be used. If individual performance for each of these GWBs is assessed at three levels of complexity, this results in a total of 126 GWBs.

Exemplary GWBs include contextual, task performance, customer service orientation, dealing with others, problem solving, and verbal and numerical comprehension. Exemplary performance predictors include conscientiousness and cognitive ability.

Regardless of the number of GWBs needed to decompose jobs fully, each one should be measured carefully, in some embodiments measured several times, using different approaches and using multiple sources of ratings. In addition, the measurement should use standard test construction methodology, such as carefully wording items and using an eighth-grade reading level. Measurement of GWBs for specific jobs may be carried out with a computer by incumbents, supervisors, or job analysts who log onto a selection website and start working through a standardized questionnaire, in like manner to the Common-Metric Questionnaire of Harvey, and the Position Analysis Questionnaire (PAQ). Online administration provides a variety of practical options, such as treeing, where respondents initially assess the job in extremely general work behaviors, allowing the automatically elimination of irrelevant subsections. The raters may select the example that most closely matches their situation, but for purposes of synthetic validity, it still represents the more general GWB. Consequently, the entire pool of items may run into the thousands, as it does with the CMQ, although only a small proportion of these are experienced by the raters.

Below are listed a possible set of GWB questions, the first 42 of which are based on the O*NET job analysis taxonomy. To avoid limitations associated with holistic (i.e., abstract single item measures) GWB rating, professional job analysts may be used. In addition, the questions may be often anchored, that is illustrated, with specific jobs and tasks. For example, for “Assisting and Caring for Others,” typical professions include: Mental Health Counselors, Medical Assistants, and Registered Nurses. Typical tasks include: work with persons with mental disabilities or illnesses, deliver babies, and assist patient in walking or exercising. For web assessment of the GWBs applicable to a job, an evaluator may be asked to view a screen showing the GWBs outlined below and, by clicking on a suitable screen element, rate the importance of the GWB to the job under consideration. A rating scale could use 1-5 and “not applicable”. The evaluator may also indicate the level of complexity by clicking on a screen element that provides a choice between low, medium and high levels of complexity. In addition, for application of the process to numerous jobs, when the area of the screen showing the GWB is clicked, example professions may pop-up and one of the professions may be selected for rating the GWB.

Exemplary GWBs are shown below. Each heading applies to a general area and is shown in bold.

### Assessing and Analyzing Information—Obtaining, Analyzing, and Interpreting Information or Data, Including any Type of Recording Information or Decision Making.

### 1. Identifying Objects, Actions, and Events—Identifying information by categorizing, estimating, recognizing differences or similarities, and detecting changes in circumstances or events.

### 2. Analyzing Data or Information—Identifying the underlying principles, reasons, or facts of information by breaking down information or data into separate parts.

### 3. Getting Information—Observing, receiving, and otherwise obtaining information from all relevant sources.

### 4. Updating and Using Relevant Knowledge—Keeping up-to-date technically and applying new knowledge to your job.

### 5. Processing Information—Compiling, coding, categorizing, calculating, tabulating, auditing, or verifying information or data.

### 6. Interpreting the Meaning of Information for Others—Translating or explaining what information means and how it can be used.

### 7. Documenting/Recording Information—Entering, transcribing, recording, storing, or maintaining information in written or electronic/magnetic form.

### 8. Monitor Processes, Materials, or Surroundings—Monitoring and reviewing information from materials, events, or the environment, to detect or assess problems.

### 9. Evaluating Information to Determine Compliance with Standards—Using relevant information and individual judgment to determine whether events or processes comply with laws, regulations, or standards.

### 10. Judging the Qualities of Things, Services, or People—Assessing the value, importance, or quality of things or people.

### 11. Making Decisions and Solving Problems—Analyzing information and evaluating results to choose the best solution and solve problems.

### 12. Estimating the Quantifiable Characteristics of Products, Events, or Information—Estimating sizes, distances, and quantities; or determining time, costs, resources, or materials needed to perform a work activity.

### 13. Interacting With Computers—Using computers and computer systems (including hardware and software) to program, write software, set up functions, enter data, or process information.

14. Drafting, Laying Out, and Specifying Technical Devices, Parts, and Equipment—Providing documentation, detailed instructions, drawings, or specifications to tell others about how devices, parts, equipment, or structures are to be fabricated, constructed, assembled, modified, maintained, or used.
Communicating and Advising—The Job Requires Interacting With Others, Even in a Very Limited Fashion. For Example, it May Include Simply Writing Brief Notes to Other People or Something More Involved, Such as Delivering a Large Presentation.

### 15. Provide Consultation and Advice to Others—Providing guidance and expert advice to management or other groups on technical, systems-, or process-related topics.

### 16. Communicating with Supervisors, Peers, or Subordinates—Providing information to supervisors, co-workers, and subordinates by telephone, in written form, e-mail, or in person.

17. Communicating with Persons Outside Organization—Communicating with people outside the organization, representing the organization to customers, the public, government, and other external sources. This information can be exchanged in person, in writing, or by telephone or e-mail.

### Physical Activity—Job Requires Being Able to Move Physically About, Up a Telephone Pole or Just Down the Hall, or Handle Objects, Such as a Photocopier or a Wrench.

### 18. Repairing and Maintaining Mechanical Equipment—Servicing, repairing, adjusting, and testing machines, devices, moving parts, and equipment that operate primarily on the basis of mechanical (not electronic) principles.

### 19. Performing General Physical Activities—Performing physical activities that require considerable use of your arms and legs and moving your whole body, such as climbing, lifting, balancing, walking, stooping, and handling of materials.

### 20. Handling and Moving Objects—Using hands and arms in handling, installing, positioning, and moving materials, and manipulating things.

### Controlling, Repairing, and Inspecting Machines—Job Requires Interacting with Technical Equipment, Such as Cash Machine.

### 21. Controlling Machines and Processes—Using either control mechanisms or direct physical activity to operate machines or processes (not including computers or vehicles).

### 22. Inspecting Equipment, Structures, or Material—Inspecting equipment, structures, or materials to identify the cause of errors or other problems or defects.

### 23. Operating Vehicles, Mechanized Devices, or Equipment—Running, maneuvering, navigating, or driving vehicles or mechanized equipment, such as forklifts, passenger vehicles, aircraft, or water craft.

### 24. Repairing and Maintaining Electronic Equipment—Servicing, repairing, calibrating, regulating, fine-tuning, or testing machines, devices, and equipment that operate primarily on the basis of electrical or electronic (not mechanical) principles.

### 25. Repairing and Maintaining Mechanical Equipment—Servicing, repairing, adjusting, and testing machines, devices, moving parts, and equipment that operate primarily on the basis of mechanical (not electronic) principles.

### Managerial Responsibility—The Job Requires Leading, Staffing, and Developing People as Well as Handling Complaints and Being Responsible for Resources.

### 26. Staffing Organizational Units—Recruiting, interviewing, selecting, hiring, and promoting employees in an organization.

### 27. Monitoring and Controlling Resources—Monitoring and controlling resources and overseeing the spending of money.

### 28. Guiding, Directing, and Motivating Subordinates—Providing guidance and direction to subordinates, including setting performance standards and monitoring performance.

### 29. Developing and Building Teams—Encouraging and building mutual trust, respect, and cooperation among team members.

### 30. Coordinating the Work and Activities of Others—Getting members of a group to work together to accomplish tasks.

### 31. Scheduling Work and Activities—Scheduling events, programs, and activities, as well as the work of others.

### 32. Coaching and Developing Others—Identifying the developmental needs of others and coaching, mentoring, or otherwise helping others to improve their knowledge or skills.

### 33. Resolving Conflicts and Negotiating with Others—Handling complaints, settling disputes, and resolving grievances and conflicts, or otherwise negotiating with others.

### Interpersonal Relationships—Job Requires Establishing Relationships with Others for Purposes of Selling, Influencing, or Teaching.

### 34. Selling or Influencing Others—Convincing others to buy merchandise/goods or to otherwise change their minds or actions.

35. Establishing and Maintaining Interpersonal Relationships—Developing constructive and cooperative working relationships with others, and maintaining them over time.

36. Training and Teaching Others—Identifying the educational needs of others, developing formal educational or training programs or classes, and teaching or instructing others.

### Administrative Tasks—Filling in Paperwork and Developing Schedules or Plans.

### 37. Performing Administrative Activities—Performing day-to-day administrative tasks such as maintaining information files and processing paperwork.

### 38. Organizing, Planning, and Prioritizing Work—Developing specific goals and plans to prioritize, organize, and accomplish your work.

### 39. Developing Objectives and Strategies—Establishing long-range objectives and specifying the strategies and actions to achieve them.

### Caring or Helping Others—Provide Customer Service to the Public or Providing Personal Assistance for Others, Including Coworkers or Patients.

### 40. Assisting and Caring for Others—Providing personal assistance, medical attention, emotional support, or other personal care to others such as coworkers, customers, or patients.

41. Performing for or Working Directly with the Public—Performing for people or dealing directly with the public. This includes serving customers in restaurants and stores, and receiving clients or guests.

### Thinking Creatively—Developing, Designing, or Creating New Applications, Ideas, Relationships, Systems, or Products, Including Artistic Contributions.

### 42. Thinking Creatively—Developing, designing, or creating new applications, ideas, relationships, systems, or products, including artistic contributions.

### Organizational Citizenship: Helping Behavior and Organizational Loyalty.

### 43. Volunteers to help co-workers in their job.

### 44. Person cooperates with others and values team objectives.

### 45. Employee is considerate of other worker's feelings.

### 46. Motivates others and encourages them to overcome setbacks.

### 47. Employee promotes the company to others and defends it against criticism.

### 48. Employee stays loyal to the company through temporary hardships.

### 49. Employee complies with the company rules and encourages others to do so, even when no one is watching.

### Counterproductive 50. The employee shows up to work and meetings on time and takes sick leave only when necessary.

### 51. The individual is not hungover or intoxicated at work.

### 52. The personal does not damage, steal, or borrow without permission the property of the company or its coworkers.

### 53. The personal is not physically or verbally abusive or threatening to the employees or customers of the company.

The GWBs listed as numbers 43-53 are often referred to as “Organizational Citizenship” and “Counterproductive” behaviors. They are not specific to any job as they are universally relevant.

Performance predictors are also required. Performance predictors are known in the art. The performance predictors are predictive of the ability of a potential applicant for at least one job to perform the job. The performance predictors should be sufficiently broad predictors to generalize over many jobs. Better results may be obtained when the specificity level of the predictor matches that of the performance characteristic (GWB). Four types of predictors may be used in synthetic validity: i) ability and aptitudes, ii) physical, psychomotor and perceptual abilities, iii) personality, and iv) biodata. The first of these, ability and aptitudes, refer to a battery of cognitive tests. Despite the diversity in content, their predictive contributions can be largely reduced to general mental ability (GMA), with more specific abilities providing little incremental validity. A GMA measure should be included, at least in some embodiments, as it should help predict almost all GWBs.

Second, physical, psychomotor and perceptual abilities refer to a collection of attributes relevant to the physical requirements of a job. These are more difficult to assess, often precluding paper-and-pencil administration, but should help predict GWBs with a strong “hands-on” component, such as machine or tool use.

Third, personality refers to a variety of traits describing stable individual differences. To a large extent, they can be summarized by the Big Five model of extraversion, neuroticism, conscientiousness, agreeableness, and culture. Conscientiousness, followed by neuroticism, is the most important of these, and both potentially predict all GWBs. Extraversion, for example, is important for sales performance.

Fourth, biodata consist of facts regarding life history. Biodata can potentially predict any GWB, but it can be difficult to explain exactly why because the causal chain can be long. More defensible are questions regarding previous job-related experience. For each job, we can determine how long candidates or incumbents have performed the job-specific operationalization of a GWB.

However, not all of these predictors will be needed in all embodiments, as there is a fair amount of redundancy among them. Physical, psychomotor, and perceptual ability, as well as many biodata items, do not tend to incrementally predict above general mental ability. Given this overlap, some embodiment may measure GMA and the Big Five personality traits. In other embodiment, other predictors can be added.

Performance predictors may be tested using any one of a multitude of measures, such as, in the case of personality, known inventories such as the NEO-PI or the HPI. Practically, only one of these need be used, and whichever is chosen may become preferred.

Performance predictors correlate with job performance and allow us to determine how people will likely perform on the job. Though job knowledge will likely predict only specific jobs, there are variety of predictors that will likely predict how people perform on general work behaviors. These are: (i) ability and aptitudes, (ii) physical, psychomotor, and perceptual abilities, (iii) personality, and (iv) biodata. To assess predictors, there are many tests already commercially available. For example, the General Aptitude Test Battery assesses general learning ability and motor coordination. However, we are in the process of developing and selecting these tests, with the exception of personality. The personality measure HEXACO, developed by Kibeom Lee and Michael C. Ashton, may be used. It has 208 items and can be administered on line. An example question is a request to consider the statement “If I want something from a person I dislike, I will act very nicely toward that person in order to get it”, and the person taking the test is asked to indicate whether they strong disagree, disagree, are neutral, agree or strongly agree with the statement.

Once completed, in one embodiment the HEXACO, or another test, gives information about people's performance on the following scales. We expect how people score on them to predict several GWBs. For example, those higher on extraversion should on average be better at interpersonal relationships, such as “Selling or Influencing Others.”

Emotionality: Persons with high scores on the Emotionality scale tend to experience fear of physical dangers, to experience anxiety in response to life's stresses, to feel a need for emotional support from others, and to feel sentimental attachments and empathic concern in relation to others. Conversely, persons with low scores on this scale tend to feel rather unemotional, detached, and independent with regard to their personal relationships, and to feel little anxiety or fear even under stressful or frightening circumstances.

eXtraversion: Persons with high scores on the Extraversion scale tend to feel confident when leading or addressing groups of people, to enjoy social gatherings and interactions, to express oneself freely and excitedly, and to experience positive feelings of enthusiasm and energy. Conversely, persons with low scores tend to be rather reserved and unexpressive, to feel awkward when they are the center of social attention, to be somewhat less lively than others, and to be rather indifferent to social activities.

Agreeableness: Persons with high scores on the Agreeableness scale tend to compromise and cooperate with others, to be lenient in judging others, to remain patient and easily control one's temper, and to forgive the wrongs that one has suffered. Conversely, persons with low scores tend to feel anger readily in response to mistreatment, to bear grudges against those who have insulted or deceived them, to be rather critical of others' shortcomings, and to be stubborn in defending one's point of view.

Conscientiousness: Persons with high scores on the Conscientiousness scale tend to organize things (both time and physical surroundings), to work in a disciplined way toward one's goals, to strive for accuracy and perfection in one's tasks, and to deliberate carefully when making decisions. Conversely, persons with low scores tend to be unconcerned with orderly surroundings or schedules, to avoid difficult tasks or challenging goals, to be satisfied with work that contains some errors, and to make decisions on impulse or with little reflection.

Openness to experience: Persons with high scores on the Openness to Experience scale tend to become absorbed in the beauty of art and nature, to feel intellectual curiosity in various domains of knowledge, to use one's imagination freely in everyday life, and to take an interest in unusual ideas or people. Conversely, persons with low scores tend to be rather unimpressed by most works of art, to feel little interest in the natural or social sciences, to avoid creative pursuits, and to feel little attraction toward ideas that may seem radical or unconventional.

Ultimately, selection of an applicant for a job can be determined if a relationship can be found between a measure of the applicant's performance predictors and overall performance. In one expression, this can be stated as

y=Σrᵢ·xᵢ for i=1 . . . N (Prediction equation)

where y is overall performance, xᵢ is the ith performance predictor, rᵢ is the correlation between the ith performance predictor and overall performance and N is the number of performance predictors.

Equivalently, the selection procedure requires establishing the matrix shown in Table 1.

TABLE 1
The matrix between overall performance (y) and predictors (x) for a
specific job

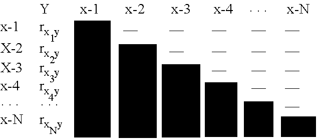

Note.
x = Performance Predictor;
y = Overall Performance.
Shaded correlations should be constant across jobs.

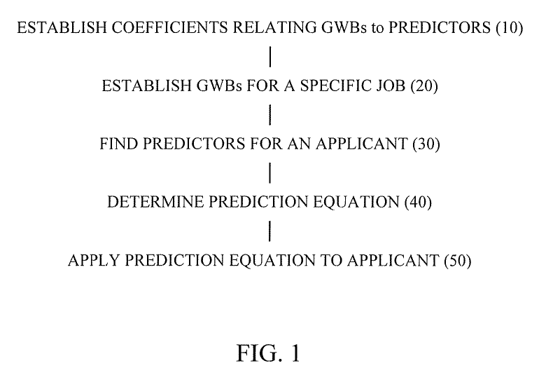

Once the performance predictors and performance characteristics have been selected, a set of correlation coefficients relating the performance characteristics for a group of jobs to performance predictors must be established (step 10, FIG. 1). These coefficients are stored in a computer. There are several ways to obtain these correlation coefficients. The coefficients comprise a synthetic validity matrix. It may be large, comprising about 8,000 coefficients (i.e., given 126 GWBs, then (126×125)/2). Each of these coefficients should be reasonably stable across different positions and organizations. One method of deriving the coefficients is to use a systematic approach, as for example by using a consortium of business and industries to establish that the GWB-predictor relationships generalize across many jobs, jobs from a variety of organizations. Assuming 126 GWBs, each employee tested can provide information on more than one coefficient, since each job has between 4.7 to 10.5 quite relevant performance predictors, and since each employee tested may be measured with all the chosen predictors, we should expect to fill out the entire matrix with about 18,000 employees filling out questionnaires. Any rating scale should be applied uniformly across jobs, in one embodiment using employees in their first two to three years, since the predictor-GWB relationship may be moderated by time or experience. The correlations thus produced yield a table such as Table 2.

TABLE 2
The job-requirement matrix for establishing the relationship between job
characteristics/general work behaviors (y) and requirements/predictors (x)

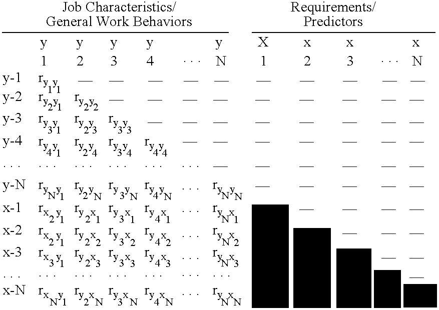

Note.
y = General Work Behavior;
x = Performance Predictor.
Shaded correlations should be constant across jobs.

To use this matrix for synthetic validity, the work behaviors must be translated into overall performance, which must be then correlated with the predictors. Analyzing jobs exclusively in terms of performance-related work behaviors eliminates the need for inference. Overall performance is the sum of these work behavior job elements.

Once the matrix of Table 2 is established, to select an applicant for a particular job (specific function), the job must first be analyzed in terms of finding the GWBs (performance characteristics) that relate to performance by someone who performs the particular job involved (step 20, FIG. 1). This may accomplished online through a questionnaire. An employer may go online and answer a series of questions that directly or indirectly reveal the GWBs applicable to the job that the employer seeks to fill. These specific GWBs or performance characteristics will be a sub-set of the GWBs used in the analysis that resulted in Table 2.

After identifying what work behaviors apply to a job, in one embodiment, the work behaviors may be weighted. Having established what work behaviors comprise a job and their level of importance, the job requirement matrix (Table 2) may be applied to develop synthetic validity coefficients. The goal is to develop regression coefficients for the overall performance measure, that is, the weighted sum of all the performance-relevant work behaviors. If any of the specific work behaviors have been weighted, this weighting must be first reflected in their variance and covariance. Multiply the variance of each weighted work behavior by the square of its weight (c), that is:

VAR_{c□x}=c²□VARₓ

Multiple the covariance of each weighted work behavior simply by its weight, that is:

COV_{C□x,y}=c□COV_{x,y}

The variance of the sum of two or more random variables is equal to the sum of each of their variances and twice their covariance, that is:

VAR_{x+y}=VARₓ+VAR_{y}+2□COV_{x,y}

Consequently, to create a new variable, we need to go to the variance-covariance or standardized correlation matrix (e.g., Table 2) and add the variance along the diagonals and the covariance both above and below.

After this, a meta-analytic multiple regression analysis, an application of structural equation modeling, is applied to the data. That is, by aggregating a variable to reflect weighted overall performance, Table 1 may be generated and the performance predictors may be regressed on the weighted overall performance, yielding the prediction equation (FIG. 1, step 40).

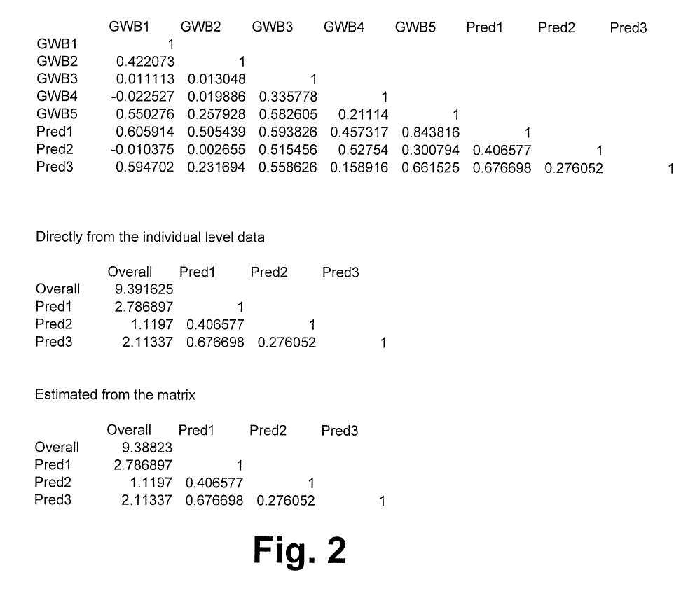

FIG. 2 shows a covariance matrix for a set of five performance characteristics (GWB1-GWB5) and three performance predictors (PRED1-PRED3), using randomly generated correlation coefficients, along with the resulting weights for the prediction equation. In this example, the GWBs were weighted as follows:

### GWB1=0, GWB2=1,

### GWB3=1, GWB4=0, GWB5=2.

Aggregated work behavior or overall performance is a weighted sum of the GWBs. For example, based on these weightings, the overall performance covariance with PRED1 is:

$$\begin{matrix}\begin{matrix}0 \cdot .6059 + 1 \cdot .5054 + 1 \cdot .5938 + \\ 0 \cdot .4573 + 2 \cdot .8438\end{matrix} = .5054 + .5938 + 1.6876 \\ = 2.79\end{matrix}$$

Regressing the predictors PRED1-PRED3 on aggregated work behavior, yields the correlation coefficients for the prediction equation, and with this data yields overall expected performance of: y=2.52·PRED1−0.018·PRED2+0.41·PRED3. Consequently, potential employees take the predictor tests, we insert their scores into the above equation and we can predict their performance.

It is also possible to keep the correlation data at an individual level and do the aggregation there. In other words, for the scores from each individual participant, you create a new variable by first multiplying each GWB by their importance weight and then adding them together. The weighted sum for these nine example cases are based on the weights of: GWB1=0, GWB2=1, GWB3=1, GWB4=0, GWB5=2.

| Case | GWB1 | GWB2 | GWB3 | GWB4 | GWB5 | Weighted Sum |
|---|---|---|---|---|---|---|
| 1 | 0.46357 | 1.44121 | −0.30547 | 1.11738 | 0.62438 | 2.3845 |
| 2 | 0.68166 | 0.82615 | −1.44594 | 0.26499 | −0.91375 | −2.44729 |
| 3 | −1.10206 | −1.65814 | 1.60816 | 1.38283 | −0.47174 | −0.99346 |
| 4 | 1.18638 | 1.10597 | −1.13815 | −0.35624 | −0.84719 | −1.72656 |
| 5 | −0.02021 | 0.47133 | −1.08557 | 0.78907 | −1.12538 | −2.865 |
| 6 | 0.68267 | 0.99106 | −0.88947 | 0.40751 | −0.36524 | −0.62889 |
| 7 | −0.42149 | −1.66141 | 0.96132 | −0.96112 | 0.51916 | 0.33823 |
| 8 | −0.86746 | 0.49409 | −1.39812 | −0.5665 | −0.79112 | −2.48627 |
| 9 | −1.53456 | −2.08528 | −0.87505 | −1.28157 | −2.02262 | −7.00557 |

Providing data is gathered across many organizations, with the rating scale and metric constant, meaningful data may be obtained. In this case, the overall performance is again determined as the weighted sum of the GWBs (performance characteristics), but the weights for the performance predictors in the prediction equation are determined by a multiple regression analysis on the entire data. However, if this approach is used, it is possible or even likely that organizational specific biases in performance rating (e.g., being stricter, being easier) will diminish the correlations, leading to inferior results. Furthermore, you are limited to using individual cases which has been assessed on all relevant GWBs. It is possible that a particular job will have a unique or rare array of GWBS, precluding this type of individual level analysis. In other words, there may be an insufficient number of relevant cases to conduct an analysis.

An alternative way of obtaining the weights for the prediction equation is to conduct a multiple regression with validity coefficients as the dependent variable and the job performance characteristics as the independent variables. This process begins with developing a correlation matrix between the validity coefficients and job characteristics, as per Table 3.

TABLE 3
The job component validity matrix for establishing the relationship
between job performance characteristics (J) and predictor
validity coefficients (P)

| | J - 1 | J - 2 | J - 3 | J - 4 | . . . | J - N |
|---|---|---|---|---|---|---|
| J - 1 | r_{J}_{₁}_{J}_{₁} | — | — | — | — | — |
| J - 2 | r_{J}_{₁}_{J}_{₂} | r_{J}_{₂}_{J}_{₂} | — | — | — | — |
| J - 3 | r_{J}_{₁}_{J}_{₃} | r_{J}_{₂}_{J}_{₃} | r_{J}_{₃}_{J}_{₃} | — | — | — |
| J - 4 | r_{J}_{₁}_{J}_{₄} | r_{J}_{₂}_{J}_{₄} | r_{J}_{₃}_{J}_{₄} | r_{J}_{₄}_{J}_{₄} | — | — |
| . . . | . . . | . . . | . . . | . . . | . . . | — |
| J - N | r_{J}_{₁}_{J}_{_{N}} | r_{J}_{₂}_{J}_{_{N}} | r_{J}_{₃}_{J}_{_{N}} | r_{J}_{₄}_{J}_{_{N}} | . . . | r_{J}_{_{N}}_{J}_{_{N}} |
| P - 1 | r_{J}_{₁}_{P}_{₁} | r_{J}_{₂}_{J}_{₃} | r_{J}_{₃}_{P}_{₁} | r_{J}_{₄}_{P}_{₁} | . . . | r_{J}_{_{N}}_{P}_{₁} |
| P - 2 | r_{J}_{₁}_{P}_{₂} | r_{J}_{₂}_{P}_{₂} | r_{J}_{₃}_{P}_{₂} | r_{J}_{₄}_{P}_{₂} | . . . | r_{J}_{_{N}}_{P}_{₂} |
| P - 3 | r_{J}_{₁}_{P}_{₃} | r_{J}_{₂}_{P}_{₃} | r_{J}_{₃}_{P}_{₃} | r_{J}_{₄}_{P}_{₄} | . . . | r_{J}_{_{N}}_{P}_{₃} |
| P - 4 | r_{J}_{₁}_{P}_{₄} | r_{J}_{₂}_{P}_{₄} | r_{J}_{₃}_{P}_{₄} | r_{J}_{₄}_{P}_{₄} | . . . | r_{J}_{_{N}}_{P}_{₄} |
| . . . | . . . | . . . | . . . | . . . | . . . | . . . |
| P - N | r_{J}_{₁}_{P}_{_{N}} | r_{J}_{₂}_{P}_{_{N}} | r_{J}_{₃}_{P}_{_{N}} | r_{J}_{₄}_{P}_{_{N}} | . . . | r_{J}_{_{N}}_{P}_{_{N}} |

Note.
J = Job Performance Characteristic;
P = Predictor Validity Coefficient (i.e., rₓ_{_{N}}_{y})

Once this table has been filled, validity coefficients (P) may be predicted using job performance characteristics (J). This can be accomplished through a Weighted Least Squares (WLS) multiple regression, where each case is weighted by either sample size or the inverse of sampling error. These regression equations are then applied to a new job, where we only have job performance characteristic information. For example, based on our WLS regression analysis, we could find that the validity coefficients can be estimated by the following regression equations:

r_{x1y}=0.3·J1+0.2·J2+0.1·J3+0.01·J4 PRED1

r_{x2y}=0.1·J1+0.3·J2+0.2·J3+0.01·J4 PRED2

r_{x3y}=0.1·J1+0.2·J2+0.01·J3+0.1·J4 PRED3

We then go to a new job and gather just the job characteristic information, finding scores of: J1=0.8, J2=0.6, J3=0.4, and J4=0.3. We insert this job characteristic information into the previously established equations and we can estimate the validity coefficients. In this case, it would be: r_{x1y}=0.403, r_{x2y}=0.343, and r_{x3y}=0.234. These are then inserted into column one of the matrix between overall performance and predictors for a specific job (i.e., Table 1), and we are ready to continue the selection process. If the resulting validity coefficients can be adequately established on the basis of job performance characteristics alone (that is, the resulting R² from the regression analysis is sufficiently high), the resulting prediction equation can be applied to the new job in selecting an applicant for the job. Ideally, we would like the precision of this methodology to exceed that of standard criterion validation. A simple selection system based on 100 (N) employees and has a validity coefficient of 0.30 (r) would still have a standard error of approximately 0.09. The equation for sampling error in this case is ((1−r²)²/(N−1))^{1/2}. If we correct for range restriction and interrater reliability in assessing work performance, that standard error could easily increase to 0.12 or 0.13. If we can exceed this precision (i.e., have a smaller standard error), we have developed a more accurate selection system.

As an example, this methodology was applied to analyzing validity coefficients derived from the General Aptitude Test Battery (GATB) database. The GATB is an assessment battery that assesses nine predictors: G (General Learning Ability), V (Verbal Aptitude), N (Numerical Aptitude), S (Spatial Aptitude), P (Form Perception), Q (Clerical Perception), K (Motor Coordination), F (Finger Dexterity), and M (Manual Dexterity). Over a period of a decade, the U.S. Department of Labor gathered validity coefficients with the GATB for thousands of jobs. When the inventor and co-workers first analyzed this data base, as indicated in the priority provisional application, they showed that this methodology works in principle. The amount of variance accounted for far exceeded previous attempts, where the former median R (i.e., the multiple correlation) between job characteristics and validity coefficients was approximately 0.26 or slightly under 7% of the variance. Despite improvement, the amount of variance accounted for was still not great, peaking at 20% for the K aptitude. There are a variety of technical reasons why this may be, not all addressable. The database has numerous errors, likely being the original inspiration for the 75% rule that indicates 25% of the variance is likely due to non-correctable errors. Also, the data does not reflect the job level (i.e., a group of similar positions within a single organization), but the occupational level (i.e., similar jobs across multiple organizations). Some precision is lost due to this grouping.

Better results are obtained if the data is re-analyzed with Positional Analysis Questionnaire (PAQ) job analysis data. The PAQ should be superior to O*NET data for several reasons. To begin with, the PAQ is designed to work with synthetic validity and there have been previous efforts to apply it. Also, the GATB database is organized according to Dictionary of Occupational Title (DOT) codes, with each code identifying a separate occupation, the same organizational structure used by the PAQ. The O*NET uses their own taxonomy which has to be crossed-walked to the DOT structure. This reduces precision considerably as it required collapsing 195 DOT occupations to fit 122 O*NET codes.

The PAQ can be summarized into 13 overall dimensions. This is important to make the ratio of predictors to performance characteristics is statistically feasible. The performance characteristics are: Decision/communication/general responsibilities (1), Machine/equipment operation (2), Clerical/related activities (3), Technical/related activities (4), Service/related activities (5), Regular day schedule vs. other work schedules (6), Routine/repetitive work activities (7), Environmental awareness (8), General physical activities (9), Supervising/coordinating other personnel (10), Public/customer/related contact activities (11), Unpleasant/hazardous/demanding environment (12), Non-typical schedule/optional apparel style (13).

To analyze this data, for the GATB database, excluding occupations with too few positions to permit statistical analysis, 192 occupations were identified, with sample sizes ranging from 10 to 1053, with an average of 211. Using the PAQ data, it was possible to match provide job analysis information for 186 out of these 192 occupations. For 150 of these occupations, an exact match was possible using DOT codes. For the remaining 36, a close match was possible, using DOT occupations that the O*NET taxonomy would consider equivalent. The number of different jobs that was analyzed using the PAQ for each of these occupations ranged from 1 to 242. For each occupation, each PAQ job estimate was averaged to provide a single overall mean.

Weighted Least Squares (WLS) multiple regression may be used for analysis of this type of meta-analytic data. WLS works by considering the accuracy associated with each data point and weighting them appropriately. For the validity coefficients, their variability was captured by sample size, which provides largely equivalent results to weighting by inverse sample error, except being less prone to outliers.

The results are reported in Table 4, in approximately the same format as the original O*NET analyses in the provisional to allow easy comparisons.

TABLE 4
A moderator analysis of GATB validity coefficients using PAQ
overall dimensions

| | | | | Var_{SE} | | Var_{MOD} | | |
|---|---|---|---|---|---|---|---|---|
| Aptitude | r̅ | K | N̅ | (%) | σ_{SE} | (%) | σ_{MOD} | Prob |
| G | .33 | 192 | 211 | 47% | .101 | 17% | .080 | .001 |
| V | .26 | 192 | 211 | 61% | .075 | 13% | .057 | .018 |
| N | .30 | 192 | 211 | 45% | .112 | 23% | .084 | >.0005 |
| S | .21 | 192 | 211 | 49% | .099 | 15% | .081 | .005 |
| P | .21 | 192 | 211 | 38% | .098 | 25% | .065 | >.0005 |
| Q | .22 | 192 | 211 | 35% | .085 | 14% | .066 | .012 |
| K | .13 | 192 | 211 | 54% | .089 | 19% | .065 | >.0005 |
| F | .14 | 192 | 211 | 62% | .068 | 13% | .051 | .029 |
| M | .15 | 192 | 211 | 44% | .096 | 10% | — | .114 |

Note.
Significant PAQ predictors at p < .05.

The fourth and fifth column report the variance due to sample error and the standard deviation based on the residual variance, respectively. The sixth column reports how much variance is due to the WLS moderator search and the seventh reports standard deviation after accounting for both sampling error and moderator variance. This estimate is critical as the lower it is, the better we can predict validity coefficients. If it is lower than 0.12, it means the precision of a synthetic validity generated selection system exceeds that generated by typical criterion validation. The last column indicates whether the WLS regression was significant.

As Table 4 reveals, useable synthetic validity has been achieved. Statistically and practically significant amount of variance has been accounted for, especially for the G, N, and P aptitudes. Also of importance, only the K aptitude proved to be better predicted by the O*NET dimensions. The PAQ outperformed O*NET for most other dimensions, typically predicting about twice as much variance.

Thus, the PAQ can be presently used to accurately predict validity coefficients. If we take the 75% rule to heart, it would appear that we already account for all the relevant variance for the GATB aptitudes of V, K, and F. Furthermore, the accuracy of synthetic validity can far exceed most traditional selection methods. For example, to achieve the same low error of estimation for the Q or K aptitude using standard criterion validation would require approximately 350 employees. Consequently, superior selection systems, more precise than traditional criterion validation, can be now be generated almost instantaneously for the most modest of costs. Improved results for the data described here could be found by additional PAQ data, a better matching of PAQ data to validity coefficients at a job level, more current data, and inclusion of biodata and personality.

Once the prediction equation has been obtained by one or more of the techniques discussed (step 40), the prediction equation may be stored in a computer for use in selecting an applicant for a job. Each applicant is invited to fill out a questionnaire, for example either on line, or on paper, and then input to a computer, to find values of specific performance predictors relating to that specific applicant for the job (specific function). The values of specific performance predictors correspond to measured values of at least some of the performance predictors known to be applicable to the specific function (step 30, FIG. 1).

Once the applicant has filled in the questionnaire, the prediction equation, which is based on the coefficients relating the performance characteristics to the performance predictors, is used to determine whether the specific performance predictors predict that the specific applicant should be selected for the specific function (step 50, FIG. 1).

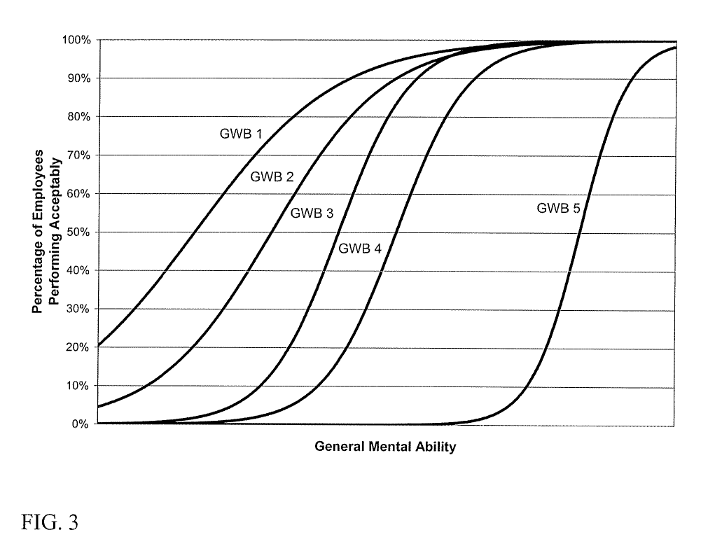

One additional benefit of this system of synthetic validity is improvement in job design. Efficiency can be gained if we group together tasks that require the same KSAs (knowledge, skills and abilities). Job elements that emphasize, for example, cognitive ability or physical strength can be allocated to people who would best perform them, taking advantage of orthogonal individual differences. Though excessive task homogeneity may be demotivating, moderately similar elements should be grouped. For any relevant predictor or predictor combination, we would like all the tasks within a job to require similar levels of knowledge, skill, or ability for acceptable completion. This can be accomplished for any task by calculating the probability of an employee reaching or exceeding an acceptable level of performance given the potency of their underlying characteristics (e.g., general mental ability). Graphing the underlying characteristics along the x-axis and the probability of success along the y-axis, we should develop something that resembles an item characteristic curve, a process we can repeat with the other GWBs. FIG. 3 provides an example of this process for five hypothetical GWBS. As can be seen, the fifth GWB is placed much higher on the x-axis than the others and is consequently introducing unusually rigorous demands on the job. The job could be made less burdensome if it was redesigned so that this GWB was either eliminated or simplified.

The economic significance of such job re-design is substantial. As Adam Smith observed, the key to human productivity is the division of labor, where people are allowed to specialize and exchange the results. By re-designing jobs so that they speak to people's strengths as well as limitations, we maximize the benefits of specialization. We can efficiently allocate tasks to those best able to complete them.

Immaterial modifications may be made to the embodiments described here without departing from what is covered by the claims. The process described here can apply to other selection procedures for a person to perform a function, other than jobs, for example selection of a mate or companion. In the claims, the word “comprising” is used in its inclusive sense and does not exclude other elements being present. The indefinite article “a” before a claim feature does not exclude more than one of the feature being present. Each one of the individual features described here may be used in one or more embodiments and is not, by virtue only of being described here, to be construed as essential to all embodiments as defined by the claims.

What is claimed is:

1. A method of making an objective selection of an applicant for a specific function using a computer managed selection system, the specific function being one of a set of functions having at least some performance characteristics in common, the method comprising the steps of:
establishing a set of coefficients relating performance characteristics of the set of functions to performance predictors, each of the performance predictors being predictive of the ability of a potential applicant for at least one function of the set of functions to perform the at least one function;
generating and electronically storing a specific set of performance characteristics selected from the performance characteristics and that relate to the specific function, the specific set of performance characteristics being performance characteristics related to the specific function;
finding values of specific performance predictors relating to a specific applicant for the specific function, where the values of specific performance predictors correspond to measured values of at least some of the performance predictors;
determining a prediction equation relating overall performance to performance predictors for the specific job, the prediction equation being obtained from the coefficients relating the performance characteristics to the performance predictors; and
applying the prediction equation to determine whether the specific performance predictors predict that the specific applicant should be selected for the specific function based on the predicted overall performance of the applicant for the specific function.

2. The method of claim 1 in which the set of functions is limited to a set of related jobs.
